(19) United States
(12) Patent Application Publication
(10) Pub. No.: US 2015/0244984 A1
(43) Pub. Date: Aug. 27, 2015

(54) INFORMATION PROCESSING METHOD AND DEVICE

(71) Applicants: Beijing Lenovo Software Ltd., Beijing (CN); Lenovo (Beijing) Co., Ltd., Beijing (CN)

(72) Inventors: Liuxin Zhang, Beijing (CN); Xiang Cao, Beijing (CN); Jinfeng Zhang, Beijing (CN); Yong Duan, Beijing (CN)

(21) Appl. No.: 14/493,662

(22) Filed: Sep. 23, 2014

(30) Foreign Application Priority Data
Feb. 24, 2014 (CN) 201410061758.6

(51) Int. Cl. H04N 7/15; H04N 13/00

(52) U.S. Cl. CPC H04N 7/15; H04N 13/0059

(57) ABSTRACT

It is provided with an information processing method and device. The method is applied to a first electronic device with a first displaying unit. The method comprises: establishing a video transmitting channel between the first electronic device and a second electronic device; collecting local 3D image data in a designated space of the first electronic device; determining a first position of the user at the first electronic device in the designated space at the current moment based on the local 3D images; receiving source 3D image data transmitted by the second electronic device via the video transmitting channel; obtaining to-be-displayed images corresponding to the first position from source 3D images corresponding to the source 3D image data; and displaying the to-be-displayed images in a displaying area of the first displaying unit.

The present application claims priority to Chinese patent application No. 201410061758.6 titled “INFORMATION PROCESSING METHOD AND DEVICE” and filed with the State Intellectual Property Office on Feb. 24, 2014, which is incorporated herein by reference in its entirety.

### BACKGROUND

1. Technical Field

The disclosure relates to the field of communication technology, and particularly to an information processing method and device.

2. Related Art

Nowadays, it is common to play videos via an electronic device. For example, video images of the other side may be displayed during a video conversation made via an electronic device. And for another example, a corresponding game video is played when playing games via an electronic device.

However, since most electronic devices display only two dimensional (2D) images, images of only a certain visual angle in the 2D video or images may be displayed in the electronic device even though the video or to-be-displayed images are in a 3D format. Therefore, users can only see images of the visual angle, resulting in a monotonous video image displaying process, which is inconvenient for users to obtain video image information omni-directionally.

### SUMMARY

In view of this, the disclosure provides an information processing method and device to allow users to view video images transmitted by other electronic devices omni-directionally.

An information processing method which comprises: collecting local 3D image data in a designated space designated by a first electronic device; determining a first position of a user in the designated space based on the local 3D image data; obtaining to-be-displayed images corresponding to the first position from source 3D images; and displaying the to-be-displayed images.

On the other hand, the disclosure further provides an information processing device applied to a first electronic device with a first displaying unit. The device includes: a channel establishing unit configured to establish a video transmitting channel between a first electronic device and a second electronic device; an image collecting unit configured to collect local 3D image data in a designated space range at the first electronic device; a position determining unit configured to determine a first position of the local user at the first electronic device in the designated space at the current moment based on the local 3D images data; a data receiving unit configured to receive source 3D image data transmitted by the second electronic device via the video transmitting channel; a data processing unit configured to obtain to-be-displayed images that corresponding to the first position from source 3D images corresponding to the source 3D image data; and a displaying unit configured to display the to-be-displayed images in a displaying area of the first displaying unit.

### BRIEF DESCRIPTION OF THE DRAWINGS

In order to more clearly illustrate the technical solutions provided in the embodiments of the disclosure or in the existing technology, drawings referred to describe the embodiments or the prior art will be briefly described hereinafter. Apparently, the drawings in the following description are just some embodiments of the disclosure. And for those skilled in the art, other drawings may be obtained based on these drawings without any creative work.

FIG. 1 is a flowchart of an information processing method according to an embodiment of the disclosure;

FIG. 2 is a flowchart of an information processing method according to another embodiment of the disclosure;

FIG. 3 is a flowchart of an information processing method according to another embodiment of the disclosure;

FIG. 4 is a flowchart of an information processing method according to another embodiment of the disclosure; and

FIG. 5 is a structural diagram of an information processing device according to an embodiment of the disclosure.

### DETAILED DESCRIPTION OF THE EMBODIMENTS

The technical solutions according to the embodiments of the disclosure will be described clearly and completely as follows in conjunction with the appended drawings. As is apparent, the embodiments disclosed hereunder are not the whole but just part of the embodiments of the disclosure. All the other embodiments obtained by those skilled in the art based on the embodiments of the disclosure without any creative work shall belong to the scope of protection sought for in the present disclosure.

Embodiments of the disclosure provide an information processing method, which allows users to view video images omni-directionally and flexibly, thereby improves the user experience.

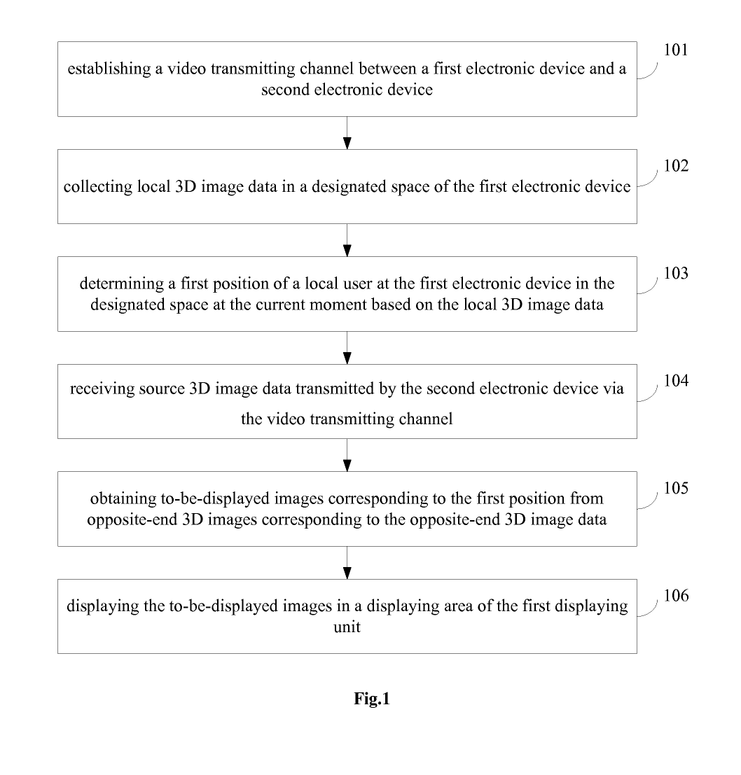

Referring to FIG. 1, which illustrates a flowchart of an information processing method according to an embodiment of the disclosure. The method provided in the present embodiment is applied to a first electronic device with a first displaying unit, where the displaying unit of the first electronic device is named as the first displaying unit only for conveniently distinguishing from displaying units of other electronic devices. The first electronic device may be a cell phone, a laptop or a desktop, etc. The method according to the embodiment may include steps 101-106.

In step 101, a video transmitting channel is established between the first electronic device and a second electronic device.

Video data may be transmitted via the video transmitting channel between the first electronic device and the second electronic device. The second electronic device may be a terminal device the same as or different from the first electronic device, or the second electronic device may also be a server stored with video data.

The video transmitting channel may be a bidirectional transmitting channel, or a unidirectional transmitting channel.

For example, in a case that the second electronic device is a terminal device, the first electronic device may establish a video communication with the second electronic device. The second electronic device transmits video data stored or collected in real time by itself to the first electronic device. The first electronic device may also transmit local video data to the second electronic device.

For another example, the second electronic device may also be a server. Taking a server corresponding to an online game for an instance, the first electronic device may receive game video transmitted by the server.

In step 102, local 3D image data in a designated space range of the first electronic device are collected.

The first electronic device may collect 3D images. For example, the first electronic device has a 3D camera, e.g., a 3D camera provided above a first displaying unit of the first electronic device, or a 3D camera is inserted inside a first displaying unit of the first electronic device; surely, a 3D camera can be connected externally to the first electronic device.

Optionally, in order to obtain a real 3D scene in the designated space of the first electronic device, the local 3D image data collected by the first electronic device may include data of multiple local 3D images from different visual angles.

In step 103, a first position of the local user at the first electronic device in the designated space at the current moment is determined based on the local 3D image data.

In a case that the user is in the designated space, the 3D images collected by the first electronic device may include image information of the user. Position information of the user in the designated space may be analyzed based on the 3D image data.

The position of the local user at the first electronic device in the designated space at the first electronic device is called a first position to distinguish from a position of a user at a second electronic device in a space at a second electronic device.

In step 104, source 3D image data transmitted by the second electronic device via the video transmitting channel are received.

In step 105, to-be-displayed images that corresponding to the first position are obtained from source 3D images corresponding to the source 3D image data.

In the embodiments of the disclosure, 3D image data transmitted by a second electronic device are called source 3D image data to distinguish from local 3D image data at the first electronic device. Video data transmitted by the second electronic device are also 3D image data.

Since different positions of a user in the first space leads to different directions of the user in relation to the first displaying interface of the first electronic device, the user may prefer presenting source images that corresponding to the current position when views images transmitted by the second electronic device via the first displaying unit.

Therefore, in order to allow the local user at the first electronic device to view images more clearly and completely at the first position, it requires the first electronic device to obtain source images that corresponding to the first position and take the source images that corresponding to the first position as to-be-displayed images.

In step 106, the to-be-displayed images are displayed in a displaying area of the first displaying unit.

In the present embodiment, a first position of a user in a designated space at the first electronic device is determined after a video data transmitting channel between a first electronic device and a second electronic device is established, and to-be-displayed images corresponding to the first position are obtained from source 3D images corresponding to the source 3D image data and displayed after source 3D image data are received. Therefore, source images suitable to be viewed the user's current position may be determined in real time based on the changes of the user's position at the first electronic device, which allows the user to always view source images that corresponding to the current position, and provides a more comprehensive display of images and an improved user experience in viewing video images.

It shall be understood that in any embodiment of the disclosure, dimensions of to-be-displayed images obtained by the first electronic device are different since dimensions of images that can be displayed by a first displaying unit are different. In a case that the first displaying unit is a displaying unit that can display 3D images, to-be-displayed images determined by the first electronic device from 3D images corresponding to the source 3D image data may also be to-be-displayed 3D images and may be displayed in the first displaying unit. In a case that the first displaying unit is a displaying unit that can only display 2D images, the first electronic device may directly determine 2D to-be-displayed images, or display 2D source images in the first displaying unit after determining to-be-displayed 3D images.

It shall be understood that there may be multiple ways to obtain to-be-displayed images corresponding to the first position. Some different ways of implementation are described as follows.

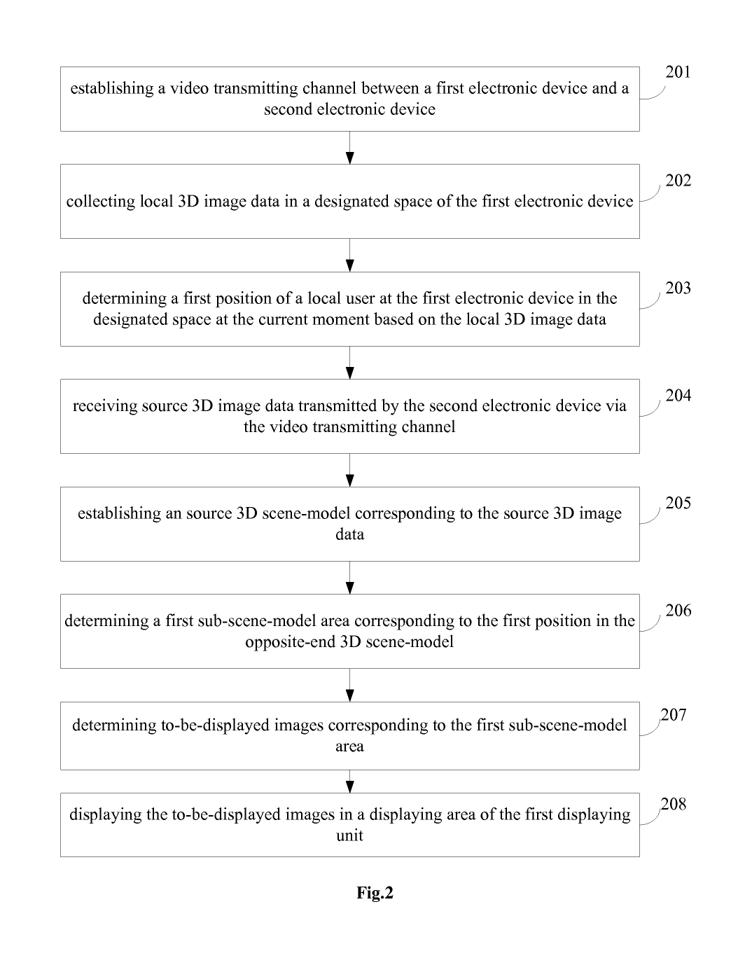

Referring to FIG. 2, which illustrates a flowchart of an information processing method according to another embodiment of the disclosure. The method according to the present embodiment may be applied to a first electronic device with a first displaying unit. The first electronic device may be a cell phone, a lap top or a desk top, etc. The method according to the present embodiment may include steps 201-208.

In step 201, a video transmitting channel between the first electronic device and a second electronic device is established.

In step 202, local 3D image data in a designated space of the first electronic device are collected.

In step 203, a first position of a local user at the first electronic device in the designated space at the current moment is determined based on the local 3D image data.

In step 204, source 3D image data transmitted by the second electronic device via the video transmitting channel are received.

In the present embodiment, the second electronic device may directly transmit the source 3D image data collected or stored by itself to the first electronic device. No special treatment is required.

In step 205, an source 3D scene-model corresponding to the source 3D image data is established.

In the present embodiment, data of multiple 3D images at different locations and from different visual angles may be obtained from the source 3D image data transmitted by the second electronic device. The first electronic device may establish a 3D model based on the source 3D image data, and thereby obtaining an source 3D scene-model.

It shall be understood that in a case that the first electronic device and the second electronic device perform a real time video communication, what is transmitted by the second electronic device is local real time 3D image data of the second electronic device. Accordingly, the established source 3D scene-model is a scene-model at the second electronic device. And in a case that what the second electronic device transmits to the first electronic device is virtual 3D video data, what is established the first electronic device is a virtual 3D scene-model. For example, in a case that the second electronic device transmits a 3D game video or a 3D animated video, etc., the first electronic device may establish a corresponding game scene-model or animated model at the current moment based on the 3D image data transmitted by the second electronic device.

The way of establishing a 3D scene-model based on 3D image data may be referred to any existing way of establishing 3D scene-model, which shall not be limited herein.

In step 206, a first sub-scene-model area that corresponding to the first position is determined in the source 3D scene-model.

After the 3D scene-model is determined, a model area where the 3D scene-model can be viewed at the first position is determined in the 3D model, and a first sub-scene-model that corresponding to the first position is further obtained.

The first sub-scene-model area is a part of an area in the source 3D scene model.

It shall be understood that since the first position is a position of a user at the first electronic device in the designated space of the first electronic device, and the source 3D scene-model is a scene-model in another space, for the purpose of a reasonable conversion to determine a model area in the source 3D scene-model that corresponding to the first position, the correspondence between the spatial coordinate at the first electronic device and that in the source 3D scene-model may be predetermined or determined in real time to further correspond the first position to a certain position in the source 3D scene-model.

Take a real time video communication between a first electronic device and a second electronic device as an example. The location of the screen of the first electronic device and that of the second electronic device may be taken as a benchmark, and the two positions may be deemed to be in the same position in the same spatial coordinate system. The first electronic device collects local 3D images in a space designated in a screen, and analyzes a first position of a user in relation to the screen of the first electronic device. The first position may also be directly applied to the 3D scene-model at the second electronic device, to further determine the first sub-scene-model area based on the first position.

In step 207, to-be-displayed images corresponding to the first sub-scene-model area are determined.

Corresponding to-be-displayed images may be obtained by plane image conversion to the first sub-scene-model area, and the to-be-displayed images may reflect images in the first sub-scene-model area.

Surely, to-be-displayed images recovered based on the first sub-scene-model area may be a frame of 3D image or a frame of 2D image, which may be set according to the displaying demands.

In step 208, the to-be-displayed images are displayed in a displaying area of the first displaying unit.

In the present embodiment, the first electronic device may establish an source 3D scene-model corresponding to the source 3D image data after receiving source 3D image data transmitted by the second electronic device, and determine in the 3D scene-model a first sub-scene model suitable to be viewed by the local user in the current first position. Thereby to-be-displayed images corresponding to the first sub-scene-model are determined. i.e., to-be-displayed images suitable to be viewed by the user in the first position are determined and displayed, which achieves displaying scene images suitable to visual angle of the user based on the position of the user, allows the user to see source images from different visual angles by changing its own positions, provides the user a feeling as if he or she is right in the scene, and thereby improves the user experience.

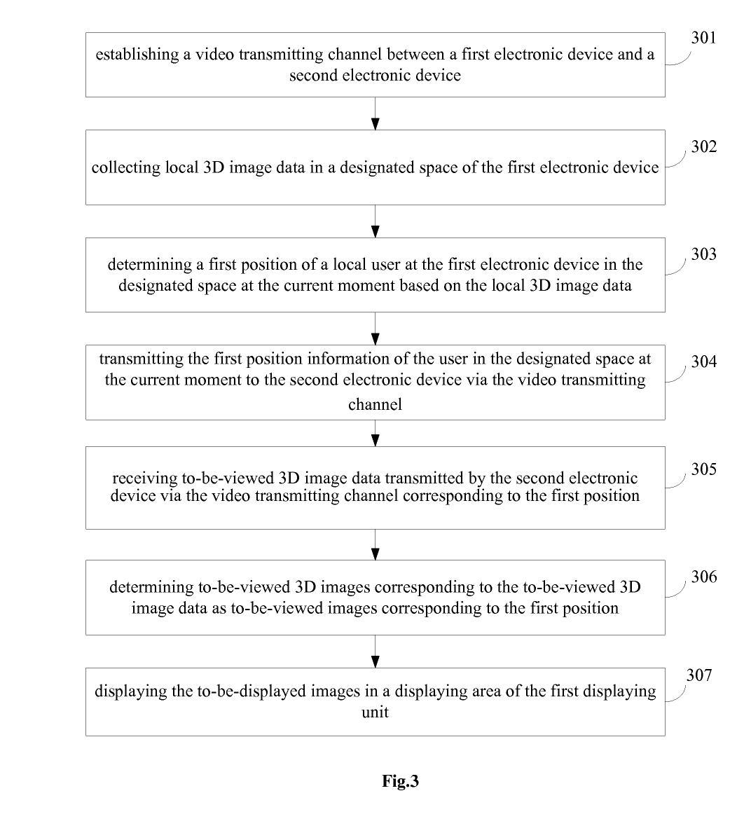

On the other hand, a second electronic device may also transmit images suitable to be viewed by a visual angle of the user to the first electronic device, to facilitate the second electronic device to directly display images suitable to be viewed by a visual angle of the user. Referring to FIG. 3, which illustrates a flowchart of an information processing method according to another embodiment of the disclosure. The method provided in the disclosure may be applied to a first electronic device with a first displaying unit. The first electronic device may be a cell phone, a laptop or a desktop, etc. The method provided in the present embodiment may include steps 301-307.

In step 301, a video transmitting channel between a first electronic device and a second electronic device is established.

In step 302, local 3D image data in a designated space of the first electronic device are collected.

In step 303, a first position of a local user at the first electronic device in the designated space at the current moment is determined based on the local 3D images.

In step 304, the first position information of the user in the designated space at the current moment is transmitted to the second electronic device via the video transmitting channel.

In step 305, to-be-displayed 3D image data transmitted by the second electronic device via the video transmitting channel, which is corresponding to the first position are received.

In the present embodiment, it requires to transmit the first position information to the second electronic device for the second electronic device to determine images corresponding to an area which is suitable to be viewed from a visual angle of the user at the first position from the 3D images at the second electronic device based on the first position of the user at the first electronic device.

After the second electronic device receives the first position, the way of determining the source 3D image data corresponding to the first position may be similar to the process of determining the to-be-displayed images at the first electronic device in the first embodiment. For example, the second electronic device determines a source 3D scene-model corresponding to source 3D image data collected or to be transmitted by the second electronic device and a first sub-scene-model area in the source 3D scene-model corresponding to the first position, to further determine to-be-displayed 3D image data corresponding to the first sub-scene-model area.

Optionally, after receiving the first position information, the second electronic device may also determine a first sub-scene-model area corresponding to the position after converting the first position as a corresponding position at the second electronic device based on the predetermined spatial position correspondence.

Surely, it requires no conversion in a case that it is default that the first position determined by the first electronic device also corresponds to the sub-scene-model area at the second electronic device. For example, it requires no position conversion in a case that the first position is a position information in relation to the displaying unit of the first electronic device, the source 3D model area established by the second electronic device is also a model space that corresponds to the displaying unit of the second electronic device, and that the spatial positions of the screens of the first electronic device and the second electronic device locate are deemed as the same.

In step 306, to-be-displayed 3D images corresponding to the to-be-displayed 3D image data are determined as to-be-displayed images corresponding to the first position.

In the present embodiment, 3D image data transmitted by the second electronic device to the first electronic device are to-be-displayed 3D image data suitable to be viewed by the user at the first electronic device in the current first position. Therefore, the first electronic device does not need to perform such as extraction process to the to-be-displayed 3D image data.

Surely, after to-be-displayed 3D images corresponding to the to-be-displayed 3D image data are determined, in view of dimensions that the first displaying unit can display, the to-be-displayed 3D images may be converted into 2D to-be-displayed images in a case that it is necessary to display them as 2D images on the first displaying interface; or the to-be-displayed 3D images may be directly determined as to-be-displayed images to be output in a case that the first displaying unit can display 3D images.

In step 307, the to-be-displayed images are displayed in a displaying area of the first displaying unit.

In any one of the above embodiments, the determined first position of the local user at the first electronic device in the designated space may also be only the user's eyesight direction. For example, the process may also be performing a face detection over the local 3D images, determining the eyesight that the eyeballs of the face in this image in the 3D images, and establishing a local 3D scene-model based on the local 3D images; determining a first eyesight direction that the eyeballs in the local 3D model based on the eyesight that the eyeballs of the face in the 3D images; and determining to-be-displayed 3D images that corresponding to the first eyesight direction from the 3D images corresponding to the source 3D image data based on the first eyesight direction.

Optionally, in view of that the user's body location, body motion, head motion and facing direction, etc. may all reflect the user's visual angle, spatial location of the user of the local electronic device in the designated space at the current moment may also be analyzed based on user image information contained in local 3D image data after the local 3D image data of the first electronic device are collected, and the extension direction of the user's eyesight corresponding to the spatial location may be determined. Correspondingly, the determining to-be-displayed images corresponding to the first position may include obtaining to-be-displayed images corresponding to the sub-3D-model area that intersects with the extension direction of the user's eyesight in the source 3D model corresponding to the source 3D image data.

Surely, the extension direction of the user's eyesight may also be determined in view of the location and eye movement of the user at the first electronic device, which shall not be limited herein.

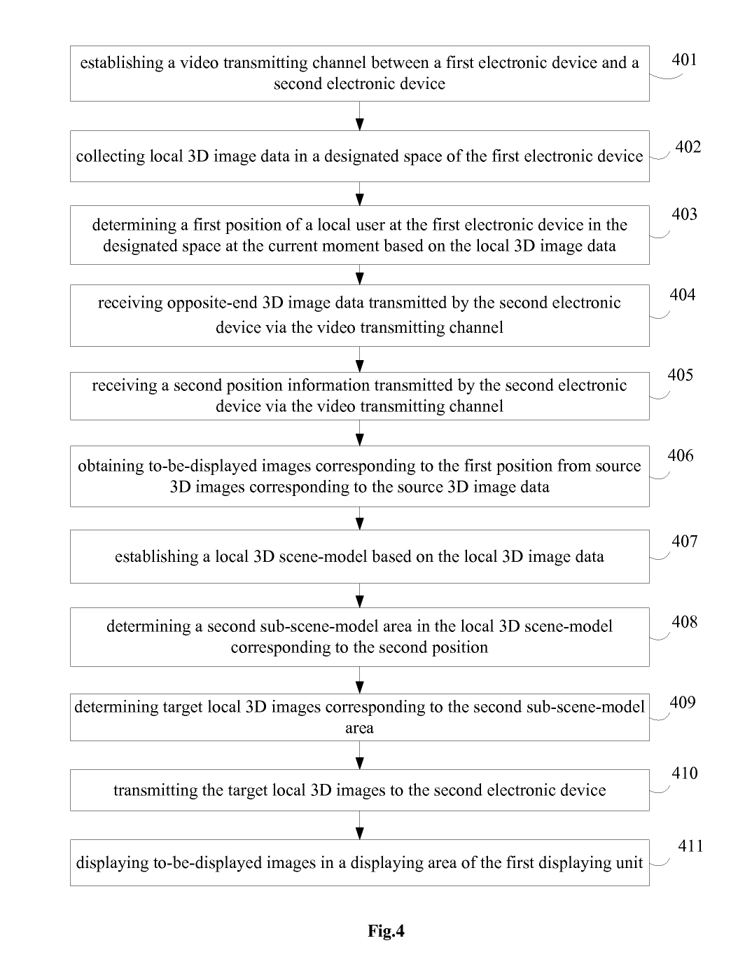

Referring to FIG. 4, which illustrates a flowchart of an information processing method according to another embodiment of the disclosure. The method provided in the disclosure may be applied to a first electronic device with a first displaying unit. The first electronic device may be a cell phone, a laptop or a desktop, etc. The method provided in the present embodiment may include steps 401-411.

In step 401, a video transmitting channel between a first electronic device and a second electronic device is established.

In step 402, local 3D image data in a designated space of the first electronic device are collected.

In step 403, a first position of the local user at the first electronic device in the designated space at the current moment is determined based on the local 3D images data.

In step 404, source 3D image data transmitted by the second electronic device via the video transmitting channel are received.

In step 405, second position information transmitted by the second electronic device via the video transmitting channel is received.

The second position is a position of the user at the second electronic device in a space range at the second electronic device.

The present embodiment applies to real time video communications between a first electronic device and a second electronic device. After collecting 3D image data at the second electronic device, the second electronic device may determine a second position of the user at the second electronic device based on the 3D image data at the second electronic device and transmit the second position to the first electronic device, to enable the first electronic device to determine images that corresponding to the second position from the local 3D images at the first electronic device.

In step 406, to-be-displayed images corresponding to the first position are obtained from source 3D images corresponding to the source 3D image data.

In the present embodiment, the way for determining to-be-displayed images may adopt those as described in any embodiment, which shall not be limited herein.

In step 407, a local 3D scene-model is established based on the local 3D image data.

In step 408, a second sub-scene-model area corresponding to the second position is determined in the local 3D scene-model.

In step 409, target local 3D images corresponding to the second sub-scene-model area are determined.

The first electronic device establishes a local 3D scene-model based on the local 3D image data and determines a second sub-scene-model area suitable to be viewed by the user at the second position in the local 3D scene-model based on the second position of the user at the second electronic device, and determines target local 3D images corresponding to the second sub-scene-model area, which allows the user at the second electronic device to view images suitable to be viewed from the current visual angle.

In step 410, the target local 3D images are transmitted to the second electronic device.

In step 411, the to-be-displayed images are displayed in a displaying area of the first displaying unit.

The present embodiment applies to video communications between a first electronic device and a second electronic device, enables the users at both sides to view images suitable to be viewed from the current visual angle. It seemed that the spaces to which users at both sides belong are connected via screens, and the communication realness is improved.

On the other hand, corresponding to the information processing method provided in the disclosure, it is also provided with an information process device.

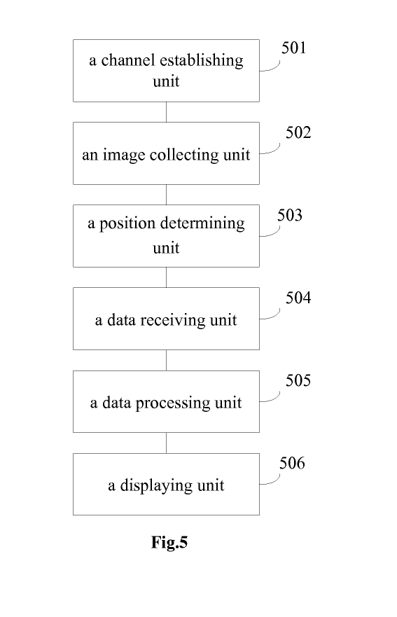

Referring to FIG. 5, which illustrates a structural view of an information process device according to the embodiment provided in the disclosure. The information process device provided in the disclosure is applied to a first electronic device with a first displaying unit. The device may include:

a channel establishing unit 501 configured to establish a video transmitting channel between a first electronic device and a second electronic device;

an image collecting unit 502 configured to collect local 3D image data in a designated space of the first electronic device;

a position determining unit 503 configured to determine a first position of the local user at the first electronic device in the designated space at the current moment based on the local 3D images;

a data receiving unit 504 configured to receive source 3D image data transmitted by the second electronic device via the video transmitting channel;

a data processing unit 505 configured to obtain to-be-displayed images corresponding to the first position from source 3D images corresponding to the source 3D image data; and

a displaying unit 506 configured to display the to-be-displayed images in a displaying area of the first displaying unit.

Optionally, in a way for implementing the device, the data processing unit may include:

a first model establishing unit configured to establish an source 3D scene-model corresponding to the source 3D image data;

a first visual angle determining unit configured to determine a first sub-scene-model area corresponding to the first position in the source 3D scene-model; and

a first target determining unit configured to determine to-be-displayed images corresponding to the first sub-scene-model area.

optionally, in another way for implementing the device, the device may further include:

a position transmitting unit configured to transmit the first position information of the user in the designated space at the current moment to the second electronic device via the video transmitting channel after a first position is determined by the position determining unit;

the data receiving unit may include:

a receiving sub-unit configured to receive to-be-displayed 3D image data transmitted by the second electronic device via the video transmitting channel which is corresponding to the first position;

the data processing unit may include:

an image determining unit configured to determine the to-be-displayed 3D images corresponding to the to-be-displayed 3D image data as to-be-displayed images corresponding to the first position.

Optionally, the position determining unit according to any one of the above embodiments may include:

a direction determining unit configured to analyze a spatial location of the local user at the first electronic device in the designated space at the current moment based on user image information contained in the local 3D image data, and determining an extension direction of the user's eyesight corresponding to the spatial location;

and, the data processing unit includes:

a data processing sub-unit configured to obtain to-be-displayed images corresponding to the sub-3D-model area that intersects with the extension direction of the user's eyesight in the source 3D model corresponding to the source 3D image data.

On the other side, the device according to any one of the above embodiments may further include:

a position receiving unit configured to receive a second position information transmitted by the second electronic device via the video transmitting channel, where the second position is position information of the user at the second electronic device in a space at the second electronic device;

a second model establishing unit configured to establish a local 3D scene-model based on the local 3D image data;

a second visual angle determining unit configured to determine a second sub-scene-model area that corresponding to the second position in the local 3D scene-model;

a second target determining unit configured to determine target local 3D images corresponding to the second sub-scene-model area; and

an image transmitting unit configured to transmit the target local 3D images to the second electronic device.

As can be known from the above technical solution, the method includes: determining a first position of the user at the first electronic device in a designated space after establishing a video data transmitting channel between a first electronic device and a second electronic device; and obtaining and displaying to-be-displayed images that corresponding to the first position from source 3D images corresponding to source 3D image data after receiving the source 3D image data. Therefore, it achieves determining in real time source images that match with suitable to be viewed by the user's view at the current position based on the changes of the user's positions at the first electronic device, which allows the user to always see source images from an angel of view suitable to a visual angle that corresponding to corresponding to the current position, resulting in a more comprehensive image display, and an improved user experience in viewing video images.

Various embodiments provided in the disclosure are described in a progressive manner. Emphasis of description of each embodiment is what it differs from other embodiments, and the same or similar part in between various embodiments can be referred to one another. The description to the device disclosed in the embodiments is relatively brief as it corresponds to the method disclosed in the embodiments, and the related part may be referred to the description of the method.

The above description to the embodiments provided in the disclosure enables those skilled in the art to implement or use the invention. Various modifications to these embodiments would be apparent to those skilled in the art. General principles defined in the disclosure can be applied in other embodiments without departing from the spirit or scope of the disclosure. Therefore, the protection scope sought for in the disclosure shall not be limited by the embodiments provided herein, but should be in consistent with the widest scope that is in conformity with the principle and novelty features herein disclosed.

What is claimed is:

1. An information processing method comprising:
collecting local 3D image data in a designated space designated by a first electronic device;
determining a first position of a user in the designated space based on the local 3D image data;
obtaining to-be-displayed images corresponding to the first position from source 3D images; and
displaying the to-be-displayed images.

2. The method according to claim 1, wherein the obtaining to-be-displayed images corresponding to the first position from source 3D images comprises:
establishing a video transmitting channel between the first electronic device and a second electronic device;
receiving source 3D image data of the source 3D images transmitted by the second electronic device via the video transmitting channel, wherein the source 3D image data is collected from the source 3D images;
establishing an source 3D scene-model corresponding to the source 3D image data;
determining a first sub-scene-model area that corresponding to the first position in the source 3D scene-model; and
determining to-be-displayed images corresponding to the first sub-scene-model area.

3. The method according to claim 1, wherein after the determining a first position of a user in the designated space based on the local 3D image data, the method further comprises:
transmitting the first position information of the user at the local first electronic device in the designated space at the current moment to the second electronic device via the video transmitting channel;
receiving to-be-displayed 3D image data transmitted by a second electronic device via the video transmitting channel that corresponding to the first position;
and the obtaining to-be-displayed images corresponding to the first position from source 3D images comprises:
determining the to-be-displayed 3D images corresponding to the to-be-displayed 3D image data as to-be-displayed images corresponding to the first position.

4. The method according to claim 2, wherein after the determining a first position of a user in the designated space based on the local 3D image data, the method further comprises:
transmitting the first position information of the user at the local first electronic device in the designated space at the current moment to the second electronic device via the video transmitting channel;
and the receiving source 3D image data transmitted by the second electronic device via the video transmitting channel comprises:
receiving to-be-displayed 3D image data transmitted by the second electronic device via the video transmitting channel that corresponding to the first position;
and the obtaining to-be-displayed images corresponding to the first position from source 3D images corresponding to the source 3D image data comprises:
determining the to-be-displayed 3D images corresponding to the to-be-displayed 3D image data as to-be-displayed images corresponding to the first position.

5. The method according to claim 1, wherein the determining a first position of a user in the designated space based on the local 3D image data comprises:
analyzing a spatial location of the user at the first electronic device in the designated space range at the current moment based on user image information contained in the local 3D image data and determining an extension direction of the user's eyesight corresponding to the spatial location;
and the obtaining to-be-displayed images corresponding to the first position from source 3D images comprises:
obtaining to-be-displayed images corresponding to the sub-scene-model area that intersects with the extension direction of the user's eyesight, from source 3D model.

6. The method according to claim 2, wherein the determining a first position of a user in the designated space based on the local 3D image data comprises:
analyzing a spatial location of the user at the first electronic device in the designated space range at the current moment based on user image information contained in the local 3D image data and determining an extension direction of the user's eyesight corresponding to the spatial location;
and the obtaining to-be-displayed images corresponding to the first position from source 3D images comprises:
obtaining to-be-displayed images corresponding to the sub-scene-model area that intersects with the extension direction of the user's eyesight, from source 3D model corresponding to the source 3D images data.

7. The method according to claim 3, wherein the determining a first position of a user in the designated space based on the local 3D image data comprises:
analyzing a spatial location of the user at the first electronic device in the designated space range at the current moment based on user image information contained in the local 3D image data and determining an extension direction of the user's eyesight corresponding to the spatial location;
and the obtaining to-be-displayed images corresponding to the first position from source 3D images comprises:
obtaining to-be-displayed images corresponding to the sub-scene-model area that intersects with the extension direction of the user's eyesight, from source 3D model corresponding to the source 3D images data.

8. The method according to claim 1, further comprising:
receiving a second position information transmitted by a second electronic device via the video transmitting channel, wherein the second position is position information of the user at the second electronic device in the space at the second electronic device;
establishing a local 3D scene-model based on the local 3D image data;
determining a second sub-scene-model area corresponding to the second position in the local 3D scene-model;
determining target local 3D images corresponding to the second sub-scene-model area; and
transmitting the target local 3D images to the second electronic device.

9. The method according to claim 2, further comprising:
receiving a second position information transmitted by the second electronic device via the video transmitting channel, wherein the second position is position information of the user at the second electronic device in the space at the second electronic device;
establishing a local 3D scene-model based on the local 3D image data;
determining a second sub-scene-model area corresponding to the second position in the local 3D scene-model;
determining target local 3D images corresponding to the second sub-scene-model area; and
transmitting the target local 3D images to the second electronic device.

10. The method according to claim 3, further comprising:
receiving a second position information transmitted by the second electronic device via the video transmitting channel, wherein the second position is position information of the user at the second electronic device in the space at the second electronic device;
establishing a local 3D scene-model based on the local 3D image data;
determining a second sub-scene-model area corresponding to the second position in the local 3D scene-model;
determining target local 3D images corresponding to the second sub-scene-model area; and
transmitting the target local 3D images to the second electronic device.

11. The method according to claim 5, further comprising:
receiving a second position information transmitted by the second electronic device via the video transmitting channel, wherein the second position is position information of the user at the second electronic device in the space at the second electronic device;
establishing a local 3D scene-model based on the local 3D image data;
determining a second sub-scene-model area corresponding to the second position in the local 3D scene-model;
determining target local 3D images corresponding to the second sub-scene-model area; and
transmitting the target local 3D images to the second electronic device.

12. An information processing device applied to a first electronic device with a first displaying unit, comprising:
an image collecting unit configured to collect local 3D image data in a designated space designated by the first electronic device;
a position determining unit configured to determine a first position of a user in the designated space based on the local 3D images data;
a data processing unit configured to obtain to-be-displayed images corresponding to the first position from source 3D images; and
a displaying unit configured to display the to-be-displayed images.

13. The device according to claim 12, wherein the data processing unit comprises:
a first model establishing unit configured to establish an source 3D scene-model corresponding to source 3D image data of the source 3D images;
a first visual angle determining unit configured to determine a first sub-scene-model area corresponding to the first position in the source 3D scene-model; and
a first target determining unit configured to determine to-be-displayed images corresponding to the first sub-scene-model area.

14. The device according to claim 12, further comprising:
a channel establishing unit configured to establish a video transmitting channel between the first electronic device and a second electronic device;
a position transmitting unit configured to transmit a first position information of the user in the designated space to the second electronic device via the video transmitting channel after the first position is determined by the position determining unit;
a data receiving unit configured to receive source 3D image data of the source 3D image transmitted by the second electronic device via the video transmitting channel;
and the data receiving unit comprises:
a receiving sub-unit configured to receive to-be-displayed 3D image data transmitted by the second electronic device via the video transmitting channel which is corresponding to the first position;
and the data processing unit comprises:
an image determining unit configured to determine to-be-displayed 3D images corresponding to the to-be-displayed 3D image data as to-be-displayed images corresponding to the first position.

15. The device according to claim 13, further comprising:
a channel establishing unit configured to establish a video transmitting channel between the first electronic device and a second electronic device;
a position transmitting unit configured to transmit a first position information of the user in the designated space to the second electronic device via the video transmitting channel after the first position is determined by the position determining unit;
a data receiving unit configured to receive source 3D image data of the source 3D image transmitted by the second electronic device via the video transmitting channel;
and the data receiving unit comprises:
a receiving sub-unit configured to receive to-be-displayed 3D image data transmitted by the second electronic device via the video transmitting channel which is corresponding to the first position;
and the data processing unit comprises:
an image determining unit configured to determine to-be-displayed 3D images corresponding to the to-be-displayed 3D image data as to-be-displayed images corresponding to the first position.

16. The device according to claim 12, wherein the position determining unit comprises:
a direction determining unit configured to analyze a spatial location of the user at the first electronic device in the designated space at the current moment based on user image information contained in the local 3D image data and determining an extension direction of the user's eyesight corresponding to the spatial location;
and the data processing unit comprises:
a data processing sub-unit configured to obtain to-be-displayed images corresponding to the sub-3D-model area that intersects with the extension direction of the user's eyesight in source 3D model.

17. The device according to claim 13, wherein the position determining unit comprises:
a direction determining unit configured to analyze a spatial location of the user at the first electronic device in the designated space at the current moment based on user image information contained in the local 3D image data and determining an extension direction of the user's eyesight corresponding to the spatial location;
and the data processing unit comprises:
a data processing sub-unit configured to obtain to-be-displayed images corresponding to the sub-3D-model area that intersects with the extension direction of the user's eyesight in source 3D model.

18. The device according to claim 14, wherein the position determining unit comprises:
a direction determining unit configured to analyze a spatial location of the user at the first electronic device in the designated space at the current moment based on user image information contained in the local 3D image data and determining an extension direction of the user's eyesight corresponding to the spatial location;
and the data processing unit comprises:
a data processing sub-unit configured to obtain to-be-displayed images corresponding to the sub-3D-model area that intersects with the extension direction of the user's eyesight in source 3D model.

19. The device according to claim 12, further comprising:
a position receiving unit configured to receive a second position information transmitted by the second electronic device via the video transmitting channel, wherein the second position is position information of the user at the second electronic device in a space at the second electronic device;
a second model establishing unit configured to establish local 3D scene-model based on the local 3D image data;
a second visual angle determining unit configured to determine a second sub-scene-model area corresponding to the second position in the local 3D scene-model;
a second target determining unit configured to determine target local 3D images corresponding to the second sub-scene-model area; and
an image transmitting unit configured to transmit the target local 3D images to the second electronic device.

20. The device according to claim 13, further comprising:
a position receiving unit configured to receive a second position information transmitted by the second electronic device via the video transmitting channel, wherein the second position is position information of the user at the second electronic device in a space at the second electronic device;
a second model establishing unit configured to establish local 3D scene-model based on the local 3D image data;
a second visual angle determining unit configured to determine a second sub-scene-model area corresponding to the second position in the local 3D scene-model;
a second target determining unit configured to determine target local 3D images corresponding to the second sub-scene-model area; and
an image transmitting unit configured to transmit the target local 3D images to the second electronic device.
